(19) United States
(12) Patent Application Publication
(10) Pub. No.: US 2026/0138015 A1
(43) Pub. Date: May 21, 2026

(54) IMAGE PROCESSING SYSTEM, IMAGE PROCESSING METHOD AND PROGRAM

(71) Applicant: Sony Interactive Entertainment Inc., Tokyo (JP)

(72) Inventors: Hirotaka Asayama, Kanagawa (JP); Ryota Ito, Kanagawa (JP); Shoichi Ikenoue, Chiba (JP)

(21) Appl. No.: 19/452,041

(22) Filed: Jan. 16, 2026

Related U.S. Application Data
(63) Continuation of application No. PCT/JP2024/025298, filed on Jul. 12, 2024.

(30) Foreign Application Priority Data
Jul. 20, 2023 (JP) 2023-118023

(51) Int. Cl. A63F 13/52; G06T 5/60; G06T 15/20

(52) U.S. Cl. CPC A63F 13/52; G06T 5/60; G06T 15/20; G06T 2207/20084; G06T 2207/30168

(57) ABSTRACT

An image processing system (1) including at least one processor, wherein the at least one processor is configured to: acquire an input frame (22) based on a processing target frame (20) that shows, from a predetermined viewpoint (C), a virtual space (VS) in which one or more game objects (O) represented by three-dimensional data are arranged and has a predetermined initial pixel count, the input frame having an input pixel count equal to or greater than an initial pixel count; acquire virtual space information (27) that is information about the virtual space (VS) available for determining a pixel value of each pixel in the input frame (22); and acquire an estimated frame (24) having an estimated pixel count greater than the input pixel count based on the input frame (22), the virtual space information (27), and a machine learning model (200).

### CROSS-REFERENCE TO RELATED APPLICATIONS

This application is a Bypass Continuation application of and claims the benefit of priority to PCT Application No. PCT/JP2024/025298, filed on Jul. 12, 2024, which claims priority to Japanese Application No. 2023-118023, filed Jul. 20, 2023 the contents of which are hereby incorporated by reference.

### TECHNICAL FIELD

The present invention relates to an image processing system, an image processing method, and a program.

### BACKGROUND TECHNOLOGY

Conventionally, a technology known as super-resolution, which uses a machine learning model to estimate a high-quality image based on a low-quality image, is known (see Non-Patent Document 1 below).

### CITATION LIST

### Non-Patent Documents

Non-Patent Document 1: Chao Dong, Chen Change Loy, Kaiming He, Xiaoou Tang. Learning a Deep Convolutional Network for Image Super-Resolution, in Proceedings of European Conference on Computer Vision (ECCV), 2014

The inventors of the present application are considering applying the above-mentioned super-resolution to virtual images. A virtual image is an image that shows, from a predetermined viewpoint, a virtual space in which one or more objects represented by three-dimensional data are arranged. Super-resolution of virtual images can be understood as the task of estimating, based on the original virtual image, an image that reproduces the appearance of the virtual space more precisely and accurately.

The virtual image is generated by performing rendering of the three-dimensional data. Rendering is performed based on information about the virtual space (hereinafter referred to as “virtual space information”) available for determining a pixel value of each pixel in the virtual image. The virtual space information includes, for example, information about the viewpoint from which the virtual space is viewed, information about the depth of the object, information about the motion of the object, information about the color and texture of the object, and information about the intensity, color, and illumination direction of a light source.

However, since the virtual image obtained by rendering may not contain sufficient information about the virtual space, there are limits to the accuracy of super-resolution based solely on the virtual image. In other words, although the virtual space information is available for determining the pixel value of each pixel in the virtual image, the virtual space information itself does not remain in the virtual image. For example, if there are originally C pieces of information about the virtual space, in the process of determining the pixel value (RGB value) of each pixel in the virtual image, the C pieces of information are reduced to three pieces of information (RGB).

An object of the present invention is to provide an image processing system, an image processing method, and a program, each of which can effectively utilize virtual space information to estimate a high-quality estimated image with high accuracy based on a low-quality input image, which is a virtual image.

### SUMMARY OF INVENTION

### Means to Solve the Problem

An image processing system according to the present invention is an image processing system including at least one processor, wherein the at least one processor is configured to: acquire an input image based on a processing target image, the processing target image having a predetermined initial pixel count and showing, from a predetermined viewpoint, a virtual space in which one or more objects represented by three-dimensional data are arranged, and the input image having an input pixel count equal to or greater than the initial pixel count; acquire virtual space information which is information about the virtual space available for determining a pixel value of each pixel in the input image; and acquire an estimated image having an estimated pixel count greater than the input pixel count, based on the input image, the virtual space information, and a machine learning model, wherein the machine learning model is trained using multiple training data sets, each of which includes a training input image, training virtual space information, and a training estimated image, the training input image is an image having the input pixel count based on a training processing target image having the initial pixel count and showing, from a predetermined viewpoint, a training virtual space in which one or more training objects represented by training three-dimensional data are arranged, the training virtual space information is information about the training virtual space available for determining a pixel value of each pixel in the training input image, and the training estimated image is an image having the estimated pixel count.

### BRIEF DESCRIPTION OF THE DRAWINGS

FIG. 1 is a diagram illustrating one example of a hardware configuration of an image processing system.

FIG. 2 is a diagram illustrating an overview of the image processing system.

FIG. 3 is a diagram illustrating schematically processing in the image processing system.

FIG. 4 is a functional block diagram illustrating one example of functions implemented in the image processing system.

FIG. 5 is a diagram illustrating processing in a rendering unit.

FIG. 6 is a diagram illustrating processing in an input frame acquisition unit.

FIG. 7A is a flow diagram illustrating one example of a processing flow executed in the image processing system.

FIG. 7B is a flow diagram illustrating one example of the processing flow executed in the image processing system.

### DESCRIPTION OF THE EMBODIMENTS

Hereinafter, one example of an embodiment of an image processing system according to the present invention will be described with reference to the drawings.

### 1. Hardware Configuration of Image Processing System

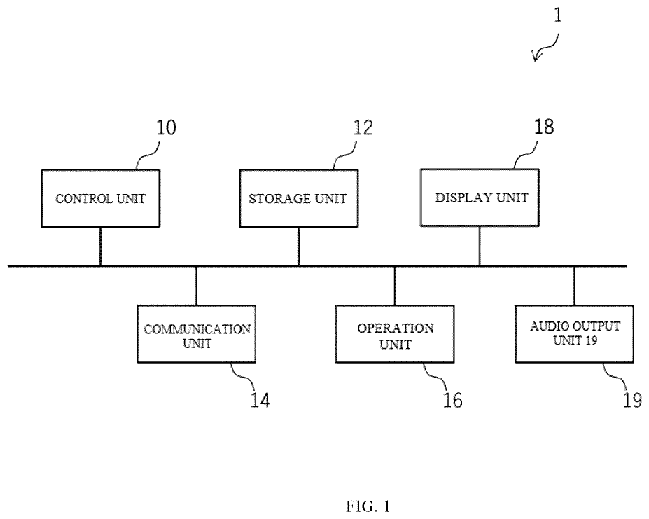

FIG. 1 is a diagram illustrating one example of a hardware configuration of an image processing system 1. The image processing system 1 is, for example, a computer such as a game console. As shown in FIG. 1, the image processing system 1 includes a control unit 10, a storage unit 12, a communication unit 14, an operation unit 16, a display unit 18, and an audio output unit 19.

The control unit 10 includes a program control device such as a CPU that operates according to a program installed in the image processing system 1, for example. The control unit 10 also includes a graphics processing unit (GPU) that draws images in a frame buffer based on graphics commands and data supplied from the CPU.

The storage unit 12 includes, for example, a main storage device such as a ROM or a RAM, and an auxiliary storage device such as an HDD or an SSD. The storage unit 12 stores, for example, programs executed by the control unit 10. The storage unit 12 stores, for example, a game program (game software) in addition to programs for implementing various functions of the image processing system 1, which will be described later. The storage unit 12 also has a frame buffer area reserved for images drawn by the GPU.

The communication unit 14 is a communication interface such as an Ethernet (registered trademark) module or a wireless LAN module.

The operation unit 16 is a user interface such as a keyboard, mouse, or game console controller, and receives operation inputs from a user and outputs signals indicating the contents of the inputs to the control unit 10.

The display unit 18 is a display device such as a liquid crystal display or an organic EL display, and displays various images according to instructions from the control unit 10.

The audio output unit 19 is, for example, a speaker, and outputs audio represented by audio data generated by the image processing system 1.

In addition to the devices mentioned above, the image processing system 1 may also include an optical disc drive that reads optical discs such as DVD-ROMs and Blu-ray (registered trademark) discs, a universal serial bus (USB) port, etc.

### 2. Overview of Image Processing System

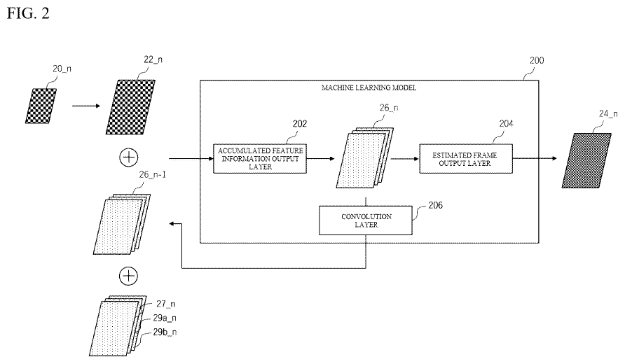

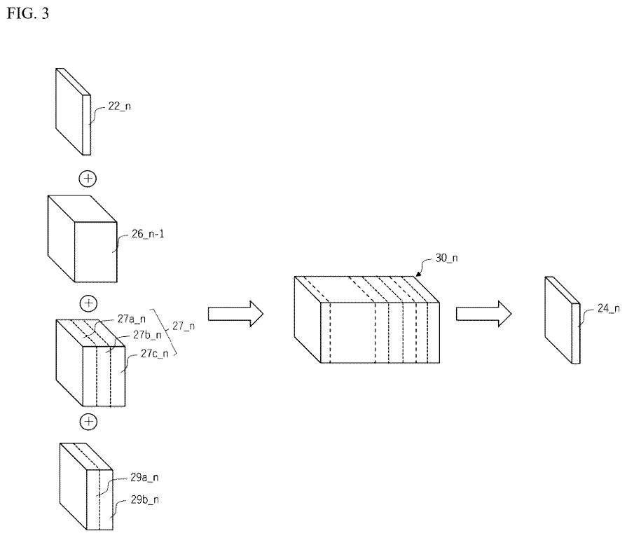

FIG. 2 is a diagram illustrating an overview of the image processing system 1. FIG. 3 is a diagram illustrating schematically processing in the image processing system 1. Here, an example will be given in which the image processing system 1 is used to improve the image quality of gameplay moving images in a game. A gameplay moving image is a moving image generated in response to the game program executed by the control unit 10 and user inputs received by the operation unit 16, and is composed of a plurality of still images (frames) that are time-series data. The image processing system 1 mainly performs the following processing.

### (1) Generation of Processing Target Frames

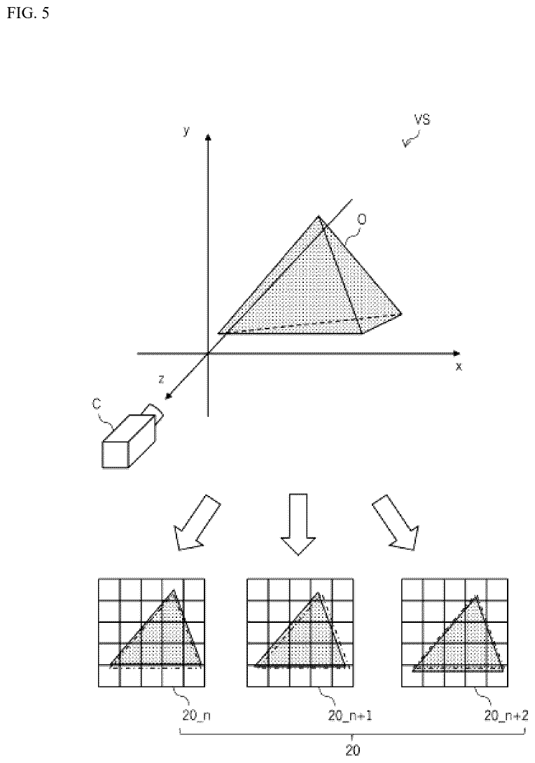

First, the image processing system 1 generates an image (a processing target frame) in which one or more game objects are drawn by rendering three-dimensional data that shows the game objects as seen from a predetermined viewpoint. This processing target frame is an image having a predetermined pixel count (initial pixel count) and a predetermined image quality (initial image quality). The processing target frame is an image that shows, from a predetermined viewpoint, a virtual space VS in which one or more game objects represented by three-dimensional data are arranged (see FIG. 5). The processing target frames are generated at predetermined time intervals. The pixel count of the processing target frame is, for example, 1920×1080 (1080p). Each generated processing target frame is not displayed directly on the display unit 18, but is temporarily stored in the storage unit 12 for subsequent processing. In the following description, processing for an nth processing target frame 20_n will be mainly illustrated; however, similar processing is also performed for other processing target frames (that is, n=2, 3, . . . , N).

### (2) Acquisition of Input Frames

Based on the acquired processing target frame 20_n, the image processing system 1 acquires a frame (input frame) 22_n having a pixel count (input pixel count) greater than the initial pixel count. The input pixel count is, for example, 3840×2160 (4K). Specifically, enlargement and interpolation processes are performed on the processing target frame 20_n to generate the input frame 22_n.

Here, it should be noted that although an input frame 22_n has a greater number of pixels than a processing target frame 20_n, its image quality has not necessarily been sufficiently improved. In other words, the image quality of a frame does not simply refer to the pixel count (high resolution).

The image quality of a frame may be evaluated based on, for example, a high signal-to-noise ratio, high spatial frequency reproducibility, and high temporal stability (fewer artifacts and flickering when multiple frames are displayed consecutively), when compared with a reference frame, either individually or based on a combination of these factors.

### (3) Acquisition of Estimated Frames

The image processing system 1 inputs the input frame 22_n to a machine learning model 200 and obtains an estimated frame 24_n. The estimated frame 24_n is an image having the same pixel count (estimated pixel count) as the input pixel count and image quality (estimated image quality) that is equal to or greater than the initial image quality. Here, in addition to the input frame 22_n, the machine learning model 200 is input with an nth piece of virtual space information 27_n and information based on an nth piece of variation information 29_n (an nth piece of variation position information 29a_n and an nth piece of ordinal number information 29b_n) (see FIGS. 2 and 3). The nth piece of virtual space information 27_n and the nth piece of variation information 29_n will be described in detail later.

Further, the machine learning model 200 is a model trained using multiple pieces of training data, each of which includes a training input frame having an input pixel count, training virtual space information, information based on training variation information, and a training estimated frame having an estimated pixel count and estimated image quality.

### (4) Acquisition of Accumulated Feature Information

The machine learning model 200 has an accumulated feature information output layer 202 that receives the input frame 22_n, the nth piece of virtual space information 27_n, the nth piece of variation position information 29a_n, and the nth piece of ordinal number information 29b_n, and outputs an nth piece of accumulated feature information 26_n that indicates features of the first to nth input frames 22 (see FIG. 2). The image processing system 1 acquires the nth piece of accumulated feature information 26_n.

The acquired nth piece of accumulated feature information 26_n is input into an estimated frame output layer 204, which outputs the nth estimated frame 24_n (see FIG. 2).

The acquired nth piece of accumulated feature information 26_n is also stored in the storage unit 12 and used to estimate the estimated frame 24_n+1 corresponding to the next processing target frame ((n+1)th processing target frame) 20_n+1.

As described above, the image processing system 1 estimates the estimated frame 24 using the input frame 22 corresponding to the current processing target frame 20 as well as the accumulated feature information 26 in which past information is accumulated. This increases the amount of information available for estimation, making it possible to obtain the high-quality estimated frame 24_n.

(5) Inputting Virtual Space Information into Machine Learning Model

Meanwhile, as stated above, the processing target frame 20, which is the virtual image, is generated by performing rendering of the three-dimensional data. Rendering is performed based on virtual space information 27, which is information about the virtual space VS available for determining a pixel value of each pixel in the processing target frame 20. The virtual space information 27 includes, for example, information about a viewpoint C from which the virtual space VS is viewed, information about the depth of a game object O, information about the motion of the game object O, information about the color and texture of the game object, and information about the intensity, color, and illumination direction of a light source (see FIG. 5).

However, since the processing target frame 20 obtained by rendering may not contain sufficient information about the virtual space VS, there are limits to the accuracy of estimation based solely on the processing target frame 20. In other words, although the virtual space information 27 is available for determining the pixel value of each pixel in the processing target frame 20, the virtual space information 27 itself does not remain in the processing target frame 20. For example, if there are originally C pieces of information about the virtual space VS, in the process of determining the pixel value (RGB value) of each pixel in the processing target frame 20, the C pieces of information are reduced to three pieces of information (RGB).

Therefore, in the image processing system 1 according to the present embodiment, in addition to the input frame 22_n, the nth piece of virtual space information 27_n, which is information about the virtual space VS available for determining the pixel value of each pixel in the nth processing target frame 20_n, is input into the machine learning model 200 (see FIGS. 2 and 3). This makes it possible to effectively utilize information about the virtual space VS, and as a result, to obtain the estimated frame 24 with high image quality and high accuracy. Hereinafter, details of the image processing system 1 will be described.

### 3. Functions Implemented in Image Processing System

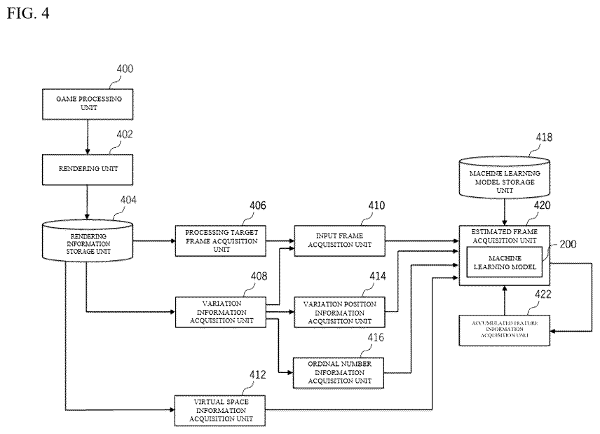

FIG. 4 is a functional block diagram illustrating one example of functions implemented in the image processing system 1. As shown in FIG. 4, the image processing system 1 includes a game processing unit 400, a rendering unit 402, a rendering information storage unit 404, a processing target frame acquisition unit 406, a variation information acquisition unit 408, an input frame acquisition unit 410, a virtual space information acquisition unit 412, a variation position information acquisition unit 414, an ordinal number information acquisition unit 416, a machine learning model storage unit 418, an estimated frame acquisition unit 420, and an accumulated feature information acquisition unit 422. The game processing unit 400, the rendering unit 402, the processing target frame acquisition unit 406, the variation information acquisition unit 408, the input frame acquisition unit 410, the virtual space information acquisition unit 412, the variation position information acquisition unit 414, the ordinal number information acquisition unit 416, the estimated frame acquisition unit 420, and the accumulated feature information acquisition unit 422 are mainly implemented by the control unit 10. The rendering information storage unit 404 and the machine learning model storage unit 418 are mainly implemented by the storage unit 12. The game processing unit 400, the rendering unit 402, and the rendering information storage unit 404 are functions provided by the game software.

### [Game Processing Unit]

The game processing unit 400 executes various processing operations related to the game. The game processing unit 400 performs processing such as arranging the game object O in the virtual space VS, operating or moving the game object O, and changing the viewpoint C from which the virtual space VS is viewed, in accordance with, for example, a game program executed by the control unit 10 and user inputs received by the operation unit 16 (see FIG. 5). The game object O is composed of primitives such as polygons represented by three-dimensional data. The three-dimensional data includes geometric information indicating positions of vertices, topological information indicating how the vertices are connected, and attribute information such as color.

### [Rendering Unit]

FIG. 5 is a diagram illustrating processing in the rendering unit 402. The rendering unit 402 generates the first to Nth (N is a natural number greater than or equal to 2) processing target frames 20 by rendering (drawing) of three-dimensional data representing one or more game objects O viewed from the predetermined viewpoint C. The processing target frame 20 is also referred to as an image that shows, from the predetermined viewpoint C, the virtual space VS in which one or more game objects O represented by the three-dimensional data are arranged. This processing target frame 20 has a predetermined initial pixel count. The rendering unit 402 performs rendering based on the results of various processing executed by the game processing unit 400. Specifically, the rendering unit 402 performs vertex processing (vertex shading) and pixel processing (pixel shading) based on the three-dimensional data representing the game object O arranged in the virtual space VS. Vertex processing includes coordinate transformation processing (perspective projection) from the view coordinate system to the screen coordinate system, and a numerical value related to variation in the viewpoint C is added to a perspective projection matrix (camera matrix) used in the coordinate transformation processing, as described below. The rendering unit 402 may perform rendering based on, for example, light source information, depth information (depth buffer), texture information, and normal information. In addition to the above processing, the rendering unit 402 may also perform processing to apply effects such as depth-of-field (DoF) and motion blur. The processing of the rendering unit 402 may be set as appropriate by, for example, game software developers. Here, the game software developers may adjust MIP of the texture according to, for example, the estimated pixel count of the estimated frame 24. This makes it possible to suppress the occurrence of noise such as moire in the estimated frame 24.

Here, the rendering unit 402 generates each processing target frame 20 by rendering so that the viewpoint C varies for each processing target frame 20. Here, even if the game processing unit 400 fixes the viewpoint C at a predetermined position, the rendering unit 402 varies the viewpoint C for each processing target frame 20. As a result, as shown in FIG. 5, the position of the displayed game object O varies in each of the processing target frames 20_n, 20_n+1, and 20_n+2. In other words, the rendering unit 402 applies jitter when generating each processing target frame 20. Specifically, the rendering unit 402 varies the viewpoint C for each processing target frame 20 by adding a numerical value corresponding to a size less than one pixel, which differs for each processing target frame 20, to the perspective projection matrix.

The rendering unit 402 performs rendering of the three-dimensional data so that the viewpoint C varies for each processing target frame 20 according to a predetermined sequence. The predetermined sequence is a sequence with a period k consisting of first to kth variation vectors (k is a natural number of 2 or more) each indicating amount and direction of variation of the viewpoint C. As such a sequence, for example, the Halton sequence can be used. As one example in the present embodiment, the rendering unit 402 performs rendering of the three-dimensional data so that the viewpoint C varies for each processing target frame 20 according to the Halton sequence with a period of 32 (that is, k=32).

### [Rendering Information Storage Unit]

The rendering information storage unit 404 stores information necessary for the rendering processing in the rendering unit 402 and information obtained as a result of the rendering processing. For example, the rendering information storage unit 404 stores the processing target frame 20. Further, the rendering information storage unit 404 stores the virtual space information 27 and the variation information 29. The virtual space information 27 and the variation information 29 will be described in detail later.

### [Processing Target Frame Acquisition Unit]

The processing target frame acquisition unit 406 acquires the first to Nth processing target frames 20, respectively. Specifically, the processing target frame acquisition unit 406 acquires the first to Nth processing target frames 20, respectively, which are stored in the rendering information storage unit 404.

### [Variation Information Acquisition Unit]

The variation information acquisition unit 408 acquires the first to Nth pieces of variation information 29, each of which is information related to the variation of the viewpoint C for each of the first to Nth processing target frames 20 during rendering. The variation information acquisition unit 408 acquires the first to Nth pieces of variation information 29, which are stored in the rendering information storage unit 404. The nth piece of variation information 29 includes a variation vector corresponding to the nth processing target frame 20_n and an ordinal number in the sequence above. When the variation vector corresponding to the nth processing target frame 20_n is the ith variation vector (i is a natural number greater than or equal to 1 and less than or equal to k), the ordinal number corresponding to the nth processing target frame 20_n is i. That is, the ordinal number corresponding to the nth processing target frame 20_n is a value indicating the ordinal number of the variation vector in the sequence to which the variation vector corresponding to the nth processing target frame 20_n corresponds.

### [Input Frame Acquisition Unit]

The input frame acquisition unit 410 acquires the first to Nth input frames 22 based on each processing target frame 20 by generating the input frame 22 that corresponds to the processing target frame 20 and has an input pixel count equal to or greater than the initial pixel count. In the present embodiment, each input frame 22 has an input pixel count that is greater than the initial pixel count. That is, in the present embodiment, each input frame 22 is an enlarged image of the processing target frame 20 corresponding to the input frame 22.

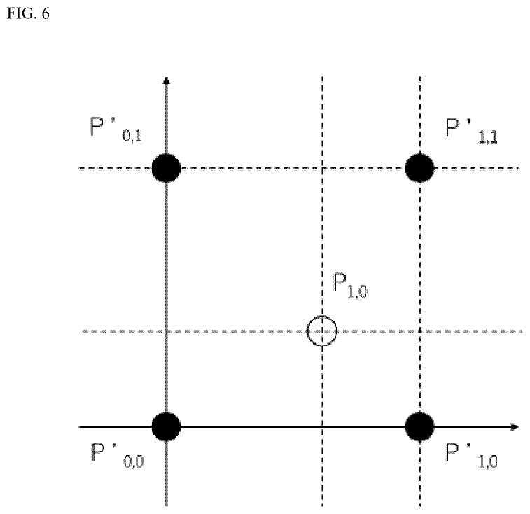

Specifically, the input frame acquisition unit 410 interpolates pixel values at positions in the processing target frame 20 corresponding to each pixel before the variation based on the variation information 29 and each pixel of each processing target frame 20, and generates each input frame 22. FIG. 6 is a diagram illustrating processing in the input frame acquisition unit 410. FIG. 6 illustrates an example in which the nth input frame 22_n is acquired. For example, as shown in FIG. 6, if the pixel center of a pixel in the input frame 22_n to be acquired is P_{1,0}, the input frame acquisition unit 410 determines the pixel value of Pio by bilinear interpolation based on the coordinates and pixel values of the pixel centers P′_{0,0}, P′_{1,0}, P′_{0,1}, and P′_{1,1} of the four pixels closest to P_{1,0} in the processing target frame 20_n. Here, P′_{1,0} is located at a position shifted from P_{1,0} by the amount of variation indicated by the variation information 29. The pixel values of the pixels newly generated by the enlargement processing are calculated in the same manner. As the interpolation method, various known methods such as bicubic interpolation and Lanczos interpolation can be used in addition to bilinear interpolation.

When rendering is performed so that the viewpoint C varies for each processing target frame 20, the amount of time-series information increases. However, by using each processing target frame 20 acquired in this way (hereinafter referred to as a “variation processing target frame”) for estimation, the estimated frame 24 with higher image quality can be acquired.

On the other hand, if the variation processing target frame (or an enlarged image thereof) is input directly into the machine learning model 200, the influence of the variation in the viewpoint C described above may result in a decrease in the accuracy of estimation.

Specifically, the image processing system 1, as described above, is configured to interpolate pixel values at positions in the processing target frame 20 corresponding to each pixel before the variation based on the variation information 29 and each pixel of each processing target frame 20, generate each input frame 22, and input this into the machine learning model 200. This corrects the influence of the variation in the viewpoint C, making it possible to prevent a decrease in the accuracy of estimation.

### [Virtual Space Information Acquisition Unit]

The virtual space information acquisition unit 412 acquires the nth piece of virtual space information 27_n, which is information about the virtual space VS available for determining a pixel value of each pixel in the nth processing target frame 20_n. The virtual space information acquisition unit 412 acquires the nth piece of virtual space information 27_n, which is stored in the rendering information storage unit 404. The virtual space information 27 includes, for example, information about a viewpoint C from which the virtual space VS is viewed, information about the depth of a game object O, information about the motion of the game object O, information about the color and texture of the game object, and information about the intensity, color, and illumination direction of a light source. The nth piece of virtual space information 27_n is also referred to as information available for rendering the nth processing target frame 20_n. The nth piece of virtual space information 27_n is not limited to information actually used in rendering the n-th processing target frame 20_n.

The nth piece of virtual space information 27_n is information having the same pixel count as the input pixel count. That is, since the nth piece of virtual space information 27_n has the same pixel count as that of the input frame 22_n, the nth piece of virtual space information 27_n can be input into the machine learning model 200 together with the input frame 22_n.

In the present embodiment, the nth piece of the virtual space information 27_n includes depth information 27a_n indicating a depth of the game object O in the virtual space VS, in which the game object O is displayed at each pixel in the nth input frame 22_n (FIG. 3). The depth information 27a is also called a depth buffer or a Z buffer. Specifically, the virtual space information acquisition unit 412 acquires original depth information having the same pixel count as the initial pixel count, and performs enlargement and interpolation processing on the original depth information to acquire the depth information 27a having the same pixel count as the input pixel count.

In the present embodiment, the nth piece of the virtual space information 27_n includes texture information 27b_n indicating a texture of the game object O, which is displayed at each pixel in the nth input frame 22_n. The texture information 27b includes, for example, a normal map and an albedo map. In the present embodiment, as one example, the texture information 27b is a normal map. Specifically, the virtual space information acquisition unit 412 acquires original texture information having the same pixel count as the initial pixel count, and performs enlargement and interpolation processing on the original texture information to acquire the texture information 27b having the same pixel count as the input pixel count.

Furthermore, in the present embodiment, the nth piece of virtual space information 27_n includes an nth piece of motion information 27c_n indicating amount and direction of movement of the game object O displayed at each pixel of the n−1th input frame 22_n−1 from the n−1st input frame 22_n−1 toward the nth input frame 22_n. The pixel value of each pixel of the nth piece of motion information 27c_n is a two-dimensional vector indicating amount and direction of motion of the game object O displayed at each pixel of the n−1th input frame 22_n−1 from the n−1st input frame 22_n−1 toward the nth input frame 22_n. The motion information 27c is also called a motion vector.

Specifically, the virtual space information acquisition unit 412 acquires original motion information having the same pixel count as the initial pixel count, and performs enlargement and interpolation processing on the original motion information to acquire the motion information 27c having the same pixel count as the input pixel count.

It goes without saying that the virtual space information 27 may include information other than the depth information 27a, the texture information 27b, and the motion information 27c.

[Variation Position Information Acquisition Unit]

The variation position information acquisition unit 414 acquires the nth piece of variation position information 29a_n based on the nth piece of variation information 29_n, in which the pixel value of each pixel is a value of one element included in the variation vector corresponding to the nth processing target frame 20_n. The nth piece of variation position information 29a_n is information having the same pixel count as the input pixel count. Specifically, the nth piece of variation position information 29a_n is information in which a value of a first element included in the variation vector corresponding to the nth processing target frame 20_n is the pixel value of each pixel, and information in which a value of a second element included in the variation vector corresponding to the nth processing target frame 20_n is the pixel value of each pixel. Here, the first element and the second element correspond to the amount of variation in the width direction and the amount of variation in the height direction of the processing target frame 20, respectively. The nth piece of variation position information 29a_n may be either information in which the value of the first element is the pixel value of each pixel, or information in which the value of the second element is the pixel value of each pixel.

### [Ordinal Number Information Acquisition Unit]

The ordinal number information acquisition unit 416 acquires the nth piece of ordinal number information 29b_n indicating the ordinal number in the sequence, based on the nth piece of variation information 29_n. The nth piece of ordinal number information 29b_n is information having the same pixel count as the input pixel count. Specifically, the ordinal number information acquisition unit 416 applies positional encoding to the ordinal number indicated by the nth piece of variation information 29_n to generate information having the same pixel count as the input pixel count, and acquires this information as the nth piece of ordinal number information 29b_n.

For example, the ordinal number information acquisition unit 416 may acquire the nth piece of ordinal number information 29b_n by applying positional coding to the ordinal number indicated by the nth piece of variation information 29_n according to the equation shown in Equation 1 below. In the following Equation 1, PE (pos, x, y) is a pixel value of a pixel located at coordinates (x,y) in the nth piece of ordinal number information 29b_n. In Equation 1, pos is the ordinal number indicated by the nth piece of variation information 29_n (0≤pos≤31), and width and height are width and height of the nth piece of ordinal number information 29b_n (i.e. the width and height of the input frame 22), respectively. Here, 0≤x≤width−1, 0≤y≤height−1.

$$PE ( pos , x , y ) = sin ( \frac{pos}{10000 \frac{x}{width}} ) cos ( \frac{pos}{10000 \frac{y}{height}} ) \qquad [ Equation 1 ]$$

### [Machine Learning Model]

The machine learning model 200 is a model that estimates the nth estimated frame 24_n based on the nth input frame 22_n. Specifically, the machine learning model 200 is a model that estimates the nth estimated frame 24_n based on the nth input frame 22_n, the nth piece of virtual space information 27_n, and the nth piece of variation information 29_n. In particular, the machine learning model 200 is a convolutional neural network (CNN). As the machine learning model 200, known models such as a multi-layered ResNet with a residual connection mechanism or a so-called encoder-decoder U-Net can be used. As the machine learning model 200, the model described in Non-Patent Document 1 may be used.

The machine learning model 200 is a model trained using multiple pieces of training data, each of which includes a training input frame having the input pixel count, training virtual space information, training variation information, and a training estimated frame having an estimated pixel count. The training input frame is an image based on a training processing target frame that shows, from a predetermined viewpoint, a training virtual space in which one or more training game objects represented by training three-dimensional data are arranged. The training input frame is obtained by rendering the training three-dimensional data in accordance with the sequence, so that the viewpoint varies for each training processing target frame. Specifically, the machine learning model 200 is trained based on a loss between the output when the nth training input frame, the n−1th piece of training accumulated feature information indicating features of the first to n−1th training input frames, the nth piece of training virtual space information (the nth piece of depth information, the nth piece of texture information, and the nth piece of motion information), and information based on the nth piece of training variation information (the nth piece of training variation position information and the nth piece of training ordinal number information) are input, and the nth training estimated frame. Here, the nth piece of training virtual space information is information about the training virtual space available for determining a pixel value of each pixel in the nth training processing target frame, and the nth piece of training variation information is information related to the variation of the viewpoint of the nth training processing target frame when rendering the training three-dimensional data. Moreover, during training, in addition to the nth piece of training virtual space information, the n−1th piece of training virtual space information is also input into the machine learning model 200. The machine learning model 200 is trained so as to reduce the loss. Various known techniques such as backpropagation can be used to train the machine learning model 200.

Specifically, the machine learning model 200 includes an accumulated feature information output layer 202, an estimated frame output layer 204, and a convolution layer 206 (see FIG. 2).

The accumulated feature information output layer 202 receives the nth input frame 22_n, the n−1th piece of accumulated feature information 26_n−1 indicating features of the first to n−1th input frames 22, the nth piece of virtual space information 27_n, and information based on the nth piece of variation information 29_n, and outputs the nth piece of accumulated feature information 26_n indicating features of the first to nth input frames 22_n. Specifically, the accumulated feature information output layer 202 receives the nth input frame 22_n, the n−1th piece of accumulated feature information 26_n−1, the nth piece of depth information 27a_n, the nth piece of texture information 27b_n, the nth piece of motion information 27c_n, the nth piece of variation position information 29a_n, and the nth piece of ordinal number information 29b_n, and outputs the nth piece of accumulated feature information 26_n. The accumulated feature information output layer 202 may be composed of, for example, one or more convolution layers. The accumulated feature information 26_n−1 is information having the same pixel count as the input pixel count (information in a bitmap format). The accumulated feature information 26_n−1 is also referred to as a feature map that indicates the features of the first to (n−1)th input frames 22.

Furthermore, in the present embodiment, in addition to the nth piece of virtual space information 27_n, the n−1th piece of virtual space information 27_n−1 is also input into the accumulated feature information output layer 202. Specifically, the n−1th piece of depth information 27a_n−1 is input into the accumulated feature information output layer 202. Note that the n−1th piece of virtual space information 27_n−1 other than the n−1th piece of depth information 27a_n−1 may also be input into the accumulated feature information output layer 202.

The accumulated feature information output layer 202 receives the first input frame 22_1, given feature information, the first piece of virtual space information 27_1, and the first piece of variation information, and outputs the first piece of accumulated feature information 26_1. When n=1, there is no previous accumulated feature information 26, so that the given feature information prepared in advance is input into the accumulated feature information output layer 202 together with the first input frame 22_1.

The estimated frame output layer 204 receives the nth piece of accumulated feature information 26_n and outputs the nth estimated frame 24_n. Like the accumulated feature information output layer 202, the estimated frame output layer 204 may be composed of, for example, one or more convolutional layers. Alternatively, the estimated frame output layer 204 may be composed of one or more transposed convolutional layers (deconvolutional layers).

The convolution layer 206 is a layer that reduces the number of channels in the accumulated feature information 26 while maintaining the pixel count. The convolution layer 206 reduces the dimension of the accumulated feature information 26, thereby reducing computational costs. The convolution layer 206 is, for example, a convolution layer with a kernel size of 1×1, but is not limited thereto.

### [Machine Learning Model Storage Unit]

The machine learning model storage unit 418 stores the machine learning model 200. Specifically, the machine learning model storage unit 418 stores parameters of the machine learning model 200 (such as the number of convolutional layers, the number of nodes used in each convolutional layer, and the weight of each node).

[Estimated Frame Acquisition Unit]

The estimated frame acquisition unit 420 acquires the first to Nth estimated frames 24, each having an estimated pixel count greater than the initial pixel count and equal to or greater than the input pixel count, based on the first to Nth input frames 22, the first to Nth pieces of virtual space information 27, the first to Nth pieces of variation information 29, and the machine learning model 200. In the present embodiment, the estimated frame 24 has an estimated pixel count that is the same as the input pixel count. More specifically, the estimated frame acquisition unit 420 inputs the nth input frame 22_n, the n−1th piece of accumulated feature information 26_n−1, the nth piece of depth information 27a_n, the n−1th piece of depth information 27a_n−1, the nth piece of texture information 27b_n, the nth piece of motion information 27c_n, the nth piece of variation position information 29a_n, and the nth piece of ordinal number information 29b_n into the machine learning model 200 to acquire the nth estimated frame 24_n. In the present embodiment, the estimated frame acquisition unit 420 acquires a combined feature 30_n by concatenating the nth input frame 22_n, the n−1th piece of accumulated feature information 26_n−1, the nth piece of depth information 27a_n, the nth piece of texture information 27b_n, the nth piece of motion information 27c_n, the nth piece of variation position information 29a_n, and the nth piece of ordinal number information 29b_n, and inputs this combined feature 30_n into the machine learning model 200 (see FIG. 3).

### [Accumulated Feature Information Acquisition Unit]

The accumulated feature information acquisition unit 422 inputs the nth input frame 22_n, the n−1th piece of accumulated feature information 26_n−1, the nth piece of depth information 27a_n, the n−1th piece of depth information 27a_n−1, the nth piece of texture information 27b_n, the nth piece of motion information 27c_n, the nth piece of variation position information 29a_n, and the nth piece of ordinal number information 29b_n into the machine learning model 200 to acquire the nth piece of accumulated feature information 26_n.

### 4. Processing Executed in Image Processing System

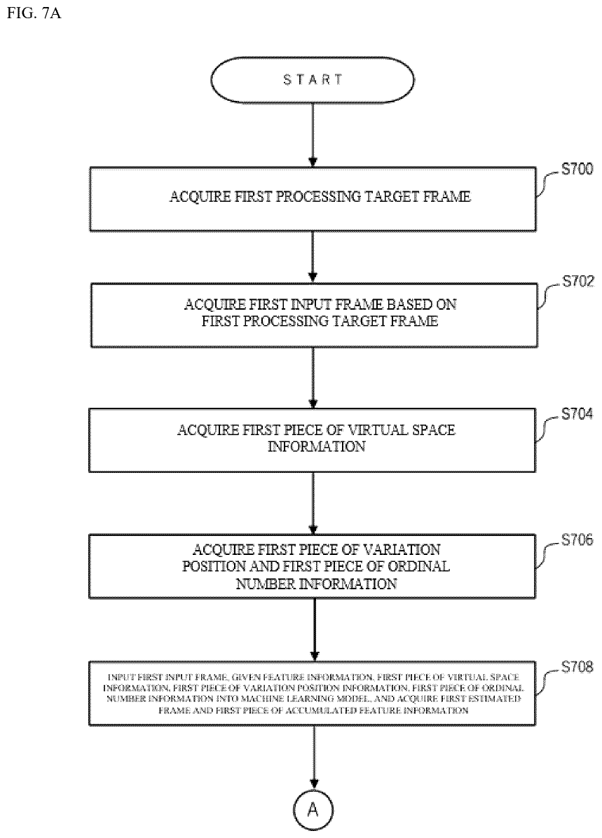

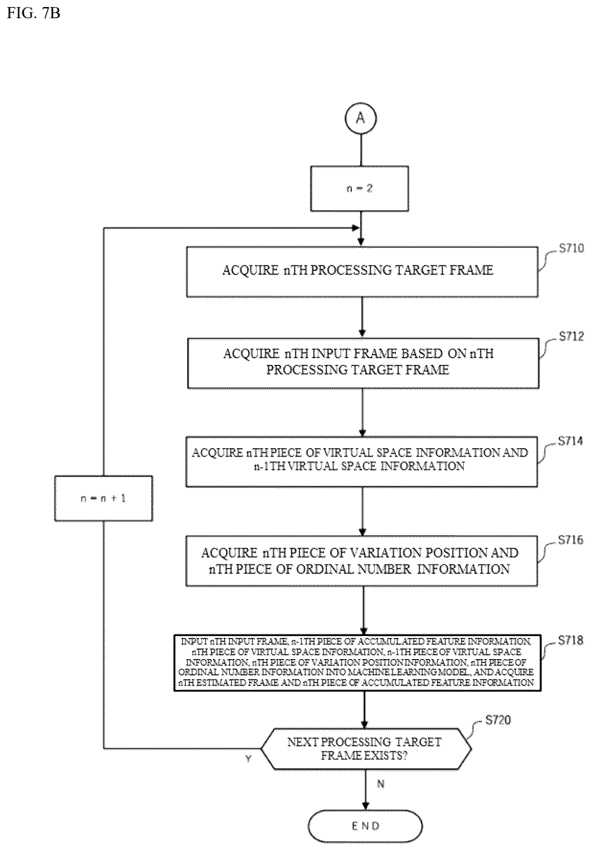

FIGS. 7A and 7B are flow diagrams illustrating one example of the processing flow executed in the image processing system 1. The processing shown in FIGS. 7A and 7B is executed by the control unit 10 operating in accordance with the programs stored in the storage unit 12.

(1) Processing for n=1

First, as shown in FIG. 7A, the control unit 10 acquires the first processing target frame 20_1 (S700). The control unit 10 acquires the first input frame 22_1 based on the first processing target frame 20_1 (S702). The control unit 10 acquires the first piece of virtual space information 27_1 (S704), and acquires the first piece of variation position information 29a_1 and the first piece of ordinal number information 29b_1 (S706). In the present embodiment, as described above, the control unit 10 acquires the first piece of depth information 27a_1, the first piece of texture information 27b_1, and the first piece of motion information 27c_1 as the first piece of virtual space information 27_1. The control unit 10 inputs the first input frame 22_1, the given feature information, the first piece of virtual space information 27_1, the first piece of variation position information 29a_1, and the first piece of ordinal number information 29b_1 into the machine learning model 200, and acquires the first estimated frame 24_1 and the first piece of accumulated feature information 26_1 (S708).

(2) Processing for n=2

Moving to FIG. 7B, the control unit 10 acquires the nth processing target frame 20_n (S710). The control unit 10 acquires the nth input frame 22_n based on the nth processing target frame 20_n (S712).

Next, the control unit 10 acquires the nth piece of virtual space information 27_n and the n−1th piece of virtual space information 27_n−1 (S714). In the present embodiment, as described above, the control unit 10 acquires the n−1th piece of depth information 27a_n−1 as the n−1th piece of virtual space information 27_n−1.

Moreover, the control unit 10 acquires the nth piece of variable position information 29a_n and the nth piece of ordinal number information 29b_n (S716). Then, the control unit 10 inputs the nth input frame 22_n, the n−1th piece of accumulated feature information 26_n−1, the nth piece of virtual space information 27_n, the n−1th piece of virtual space information 27_n−1, the nth piece of variation position information 29a_n, and the nth piece of ordinal number information 29b_n into the machine learning model 200, and acquires the nth estimated frame 24_n and the nth piece of accumulated feature information 26_n (S718). The control unit 10 determines whether or not the next frame exists (S720), and if it determines that the next frame exists (S720: Y), it increments n to n+1 and repeats the processing of S706 to S718. If the control unit 10 determines that the next frame does not exist (S720: N), it ends this processing. Moreover, if the control unit 10 determines that the next frame does not exist (S720: N), the control unit 10 may cause the display unit 18 to display the first to Nth estimated frames 24 as they are.

### 5. Summary

According to the image processing system 1 of the present embodiment described above, the nth estimated frame 24_n is estimated using the n−1th piece of accumulated feature information 26_n−1 that indicates the features of the first to n−1th input frames 22. That is, in addition to the information about the nth processing target frame 20_n, the information about the first to n−1th processing target frames 20 is available for estimation, so that the amount of information available for estimation increases, and a high-quality estimated frame 24_n can be acquired.

Furthermore, according to the image processing system 1, the nth estimated frame 24_n is acquired based on the nth input frame 22_n, the nth piece of virtual space information 27_n, and the machine learning model 200, thereby making it possible to effectively utilize information about the virtual space VS, and as a result, to acquire the estimated frame 24 with high accuracy and high image quality.

Furthermore, in the image processing system 1, the nth estimated frame 24_n is acquired further based on the nth piece of variation information 29_n. That is, as described above, if the variation processing target frame (or an enlarged image thereof) is input directly into the machine learning model 200, the influence of the variation in the viewpoint C described above may result in a decrease in the accuracy of estimation. However, in the present embodiment, the variation in the viewpoint C is taken into account when making estimations using the machine learning model 200, so that the decrease in the accuracy of the estimation can be more reliably suppressed.

Note that since the variation information 29 itself is data in a format different from that of the input frame 22, the variation information 29 itself cannot be input into the machine learning model 200. Therefore, in the image processing system 1, based on the variation information 29, the variation position information 29a and the ordinal number information 29b, which are information having the same pixel count as the input pixel count, are acquired. This makes it possible to acquire the estimated frame 24 based on the variation information 29.

Furthermore, in the image processing system 1, the nth piece of motion information 27 c_n is input into the accumulated feature information output layer 202.

In the case where the game object O is moved between the nth processing target frame 20_n and the n−1th processing target frame 20_n−1, when acquiring the nth estimated frame 24_n, if the nth input frame 22_n and the n−1th piece of accumulated feature information 26_n−1 are input directly into the machine learning model 200, ghosting may occur in which an afterimage of the game object O that was displayed in the nth input frame 22_n is displayed in the output nth estimated frame 24_n.

In the image processing system 1, as described above, the nth piece of motion information 27c_n is input into the accumulated feature information output layer 202, so that when making the estimation by the machine learning model 200, the motion of the game object O between the nth input frame 22_n and the n−1th input frame 22_n−1 is taken into consideration, thereby suppressing the ghosting mentioned above.

Furthermore, in the image processing system 1, the n−1th piece of virtual space information 27_n−1 (particularly the n−1th piece of depth information 27a_n−1) is input into the accumulated feature information output layer 202.

In the case all or part of the game object O that is not displayed in the n−1st processing target frame 20_n−1 is displayed in the nth processing target frame 20_n, when acquiring the nth estimated frame 24_n, if the nth input frame 22_n and the n−1st piece of accumulated feature information 26_n−1 are input directly into the machine learning model 200, the ghosting mentioned above may occur in the output nth estimated frame 24_n.

In the image processing system 1, as described above, the n−1th piece of depth information 27a_n−1 is input into the accumulated feature information output layer 202, so that when making the estimation by the machine learning model 200, the depth of the game object O indicated by the n−1th input frame 22_n−1, i.e. the previous frame is taken into consideration, thereby suppressing the ghosting mentioned above.

The present invention is not limited to the above-described embodiment. Furthermore, the specific character strings and numerical values described above and the specific character strings and numerical values in the drawings are examples, and the present invention is not limited to these character strings and numerical values.

For example, in the present embodiment, a case has been exemplified in which the input pixel count is greater than the initial pixel count and the input pixel count is the same as the estimated pixel count; however, the input pixel count may be the same as the initial pixel count and the estimated pixel count may be greater than the input pixel count. That is, the input frame 22 does not necessarily have to be an enlarged image of the processing target frame 20.

Furthermore, the processing target frame 20 may be input directly into the machine learning model 200.

Furthermore, while the present embodiment has illustrated a case in which the information based on the virtual space information 27 and the variation information 29 is input to the accumulated feature information output layer 202, this example is not limiting the present invention. In other words, the accumulated feature information output layer 202 may receive the nth input frame 22_n and the n−1th piece of accumulated feature information 26_n−1, and output the nth piece of accumulated feature information 26_n. In that case, the estimated frame output layer 204 may receive the nth piece of accumulated feature information 26_n, the nth piece of virtual space information 27_n, the (n−1)th piece of virtual space information 27_n−1, the nth piece of variation position information 29a_n, and the nth piece of ordinal number information 29b_n output from the accumulated feature information output layer 202, and output the nth estimated frame 24_n.

In addition, in the present embodiment, an example is given of a case where both the information based on the virtual space information 27 and the information based on the variation information 29 are input into the machine learning model 200, but it is also possible to input only one piece of the information based on the virtual space information 27 or the information based on the variation information 29 into the machine learning model 200.

In addition, in order to more reliably suppress the ghosting, processing may be performed on the n−1th piece of accumulated feature information 26_n−1 based on the nth piece of depth information 27a_n, the n−1th piece of depth information 27a_n−1, and the nth piece of motion information 27c n.

For example, an n−1th piece of auxiliary information may be acquired by applying motion compensation to the n−1th piece of accumulated feature information 26_n−1 based on the nth piece of motion information 27c_n, and this n−1th piece of auxiliary information may be input into the machine learning model 200 instead of the n−1th piece of accumulated feature information 26_n−1.

Furthermore, for example, based on the nth piece of depth information 27a_n and the n−1th piece of depth information 27a_n−1, an nth disoccluded pixel, which is a pixel among the pixels of the nth input frame 22_n at which all or part of the game object O that is not displayed in the n−1th input frame 22_n−1 is displayed, may be identified, and the n−1th piece of auxiliary information may be obtained by replacing a pixel value of the nth disoccluded pixel in the n−1th piece of accumulated feature information 26_n−1 with a predetermined value.

Furthermore, in the present embodiment, the image processing system 1 is applied to a moving image, but the image processing system 1 may also be applied to a still image.

### 6. Notes

(1) An image processing system comprising at least one processor, wherein the at least one processor is configured to:
acquire an input image based on a processing target image, the processing target image having a predetermined initial pixel count and showing, from a predetermined viewpoint, a virtual space in which one or more objects represented by three-dimensional data are arranged, and the input image having an input pixel count equal to or greater than the initial pixel count;
acquire virtual space information which is information about the virtual space available for determining a pixel value of each pixel in the processing target image; and
acquire an estimated image having an estimated pixel count greater than the input pixel count, based on the input image, the virtual space information, and a machine learning model,
wherein the machine learning model is trained using multiple training data sets, each of which includes a training input image, training virtual space information, and a training estimated image,
the training input image is an image having the input pixel count based on a training processing target image having the initial pixel count and showing, from a predetermined viewpoint, a training virtual space in which one or more training objects represented by training three-dimensional data are arranged,
the training virtual space information is information about the training virtual space available for determining a pixel value of each pixel in the training processing target image, and
the training estimated image is an image having the estimated pixel count.

(2) The image processing system according to (1), wherein the virtual space information has the same pixel count as the input pixel count.

(3) The image processing system according to (1) or (2), wherein the virtual space information includes depth information indicating a depth of the object in the virtual space, the object being displayed at each pixel in the input image.

(4) The image processing system according to any one of (1) to (3), wherein the virtual space information includes texture information indicating a texture of the object displayed at each pixel in the input image.

(5) The image processing system according to any one of (1) to (4), wherein the at least one processor is configured to:
acquire the first to Nth input images based on the first to Nth processing target images arranged in chronological order, wherein N is a natural number greater than or equal to 2;
acquire first to Nth pieces of the virtual space information corresponding to the first to Nth input images, respectively; and acquire the first to Nth estimated images based on the first to Nth input images, the first to Nth pieces of the virtual space information, and the machine learning model.

(6) The image processing system according to (5), wherein
the machine learning model includes an accumulated feature information output layer and an estimated image output layer,
the accumulated feature information output layer receives the nth input image (n=2, 3, . . . , N), the nth piece of the virtual space information, and an n−1th piece of accumulated feature information indicating features of the first to n−1th input images, and outputs an nth piece of the accumulated feature information indicating features of the 1st to nth input images, and
the estimated image output layer receives the nth piece of the accumulated feature information and outputs the nth estimated image.

(7) The image processing system according to (6), wherein the nth piece of the virtual space information includes an nth piece of motion information indicating amount and direction of motion of the object displayed at each pixel in the n−1th input image from the n−1th input image toward the nth input image.

(8) The image processing system according to (6) or (7), wherein the accumulated feature information output layer receives the nth input image, the nth piece of the virtual space information, the (n−1)th piece of the virtual space information, and the (n−1)th piece of the accumulated feature information, and outputs the nth piece of the accumulated feature information.

(9) The image processing system according to any one of (5) to (8), wherein each of the processing target images is an image obtained by rendering the three-dimensional data so that the viewpoint varies for each processing target image according to a predetermined sequence,
the predetermined sequence is a sequence with a period k consisting of first to kth variation vectors (k is a natural number greater than or equal to 2) that respectively indicate amount and direction of the viewpoint variation, and
the at least one processor is configured to:
acquire first to Nth pieces of variation information that is information related to the viewpoint variation for each of the first to Nth processing target images in the rendering; and
acquire the first to Nth estimated images based on the nth input image, the nth piece of the virtual space information, the nth piece of the variation information, and the machine learning model.

(10) The image processing system according to (9), wherein the at least one processor is configured to:
acquire an nth piece of variation position information based on the nth piece of the variation information, the nth piece of the variation position information having the same pixel count as the input pixel count and having a pixel value of each pixel as a value of one element included in the variation vector corresponding to the nth processing target image; and acquire the first to Nth estimated images based on the nth input image, the nth piece of the virtual space information, the nth piece of the variation position information, and the machine learning model.

(11) The image processing system according to (9) or (10), wherein
the at least one processor is configured to:
   acquire, based on the nth piece of the variation information, an nth piece of ordinal number information indicating an ordinal number in the sequence, and having the same pixel count as the input pixel count; and acquire the first to Nth estimated images based on the nth input image, the nth piece of the virtual space information, the nth piece of the ordinal number information, and the machine learning model.

1. An image processing system comprising at least one processor and at least one memory storing programming instructions, that upon being executed by the at least one processor, cause the image processing system to perform operations comprising:
acquire an input image based on a processing target image, the processing target image having a predetermined initial pixel count and showing, from a predetermined viewpoint, a virtual space in which one or more objects represented by three-dimensional data are arranged, and the input image having an input pixel count equal to or greater than the initial pixel count;
acquire virtual space information which is information about the virtual space available for determining a pixel value of each pixel in the processing target image; and
acquire an estimated image having an estimated pixel count greater than the input pixel count, based on the input image, the virtual space information, and a machine learning model,
wherein the machine learning model is trained using multiple training data sets, each of which includes a training input image, training virtual space information, and a training estimated image,
the training input image is an image having the input pixel count based on a training processing target image having the initial pixel count and showing, from the predetermined viewpoint, a training virtual space in which one or more training objects represented by training three-dimensional data are arranged,
the training virtual space information is information about the training virtual space available for determining a pixel value of each pixel in the training processing target image, and
the training estimated image is an image having the estimated pixel count.

2. The image processing system according to claim 1, wherein the virtual space information has a same pixel count as the input pixel count.

3. The image processing system according to claim 1, wherein the virtual space information includes depth information indicating a depth of an object of the one or more objects in the virtual space, the object being displayed at each pixel in the input image.

4. The image processing system according to claim 1, wherein the virtual space information includes texture information indicating a texture of an object of the one or more objects displayed at each pixel in the input image.

5. The image processing system according to claim 1, wherein
the programming instructions, upon execution by the at least one processor, cause the system to perform operations comprising:
acquire first to Nth input images based on first to Nth processing target images arranged in chronological order, wherein N is a natural number greater than or equal to 2;
acquire first to Nth pieces of the virtual space information corresponding to the first to Nth input images, respectively; and
acquire first to Nth estimated images based on the first to Nth input images, the first to Nth pieces of the virtual space information, and the machine learning model.

6. The image processing system according to claim 5, wherein
the machine learning model includes an accumulated feature information output layer and an estimated image output layer,
the accumulated feature information output layer receives the nth input image, wherein n is an integer greater than or equal to 1, the nth piece of the virtual space information, and an n−1th piece of accumulated feature information indicating features of first to n−1th input images, and outputs an nth piece of the accumulated feature information indicating features of the first to nth input images, and
the estimated image output layer receives the nth piece of the accumulated feature information and outputs the nth estimated image.

7. The image processing system according to claim 6, wherein
the nth piece of the virtual space information includes an nth piece of motion information indicating amount and direction of motion of a object of the one or more objects displayed at each pixel in the n−1th input image from the n−1th input image toward the nth input image.

8. The image processing system according to claim 6, wherein the accumulated feature information output layer receives the nth input image, the nth piece of the virtual space information, the n−1th piece of the virtual space information, and the n−1th piece of the accumulated feature information, and outputs the nth piece of the accumulated feature information.

9. The image processing system according to claim 6, wherein
each of the processing target images is an image obtained by rendering the three-dimensional data so that the predetermined viewpoint varies for each processing target image according to a predetermined sequence,
the predetermined sequence is a sequence with a period k consisting of first to kth variation vectors (k is a natural number greater than or equal to 2) that respectively indicate amount and direction of a viewpoint variation, and
the programming instructions, upon execution by the at least one processor, cause the system to perform operations comprising:
acquire first to Nth pieces of variation information that is information related to the viewpoint variation for each of the first to Nth processing target images in the rendering; and
acquire the first to Nth estimated images based on the nth input image, the nth piece of the virtual space information, the nth piece of the variation information, and the machine learning model.

10. The image processing system according to claim 9, wherein
the at least one processor is configured to:
acquire an nth piece of variation position information based on the nth piece of the variation information, the nth piece of the variation position information having a same pixel count as the input pixel count and having a pixel value of each pixel as a value of one element included in the variation vector corresponding to the nth processing target image; and
acquire the first to Nth estimated images based on the nth input image, the nth piece of the virtual space information, the nth piece of the variation position information, and the machine learning model.

11. The image processing system according to claim 9, wherein
the at least one processor is configured to:
acquire, based on the nth piece of the variation information, an nth piece of ordinal number information indicating an ordinal number in the sequence, and having a same pixel count as the input pixel count; and
acquire the first to Nth estimated images based on the nth input image, the nth piece of the virtual space information, the nth piece of the ordinal number information, and the machine learning model.

12. An image processing system comprising at least one processor,
wherein the at least one processor is configured to:
acquire first to Nth input images each having an input pixel count equal to or greater than an initial pixel count based on first to Nth processing target images (where N is a natural number greater than or equal to 2) that show, from a predetermined viewpoint, a virtual space in which one or more objects represented by three-dimensional data are arranged, have a predetermined initial pixel count, and are arranged in chronological order, wherein each of the processing target images is an image obtained by rendering the three-dimensional data so that the viewpoint varies for each processing target image according to a predetermined sequence, and the predetermined sequence is a sequence with a period k consisting of first to kth variation vectors (k is a natural number greater than or equal to 2) that respectively indicate amount and direction of a viewpoint variation;
acquires first to Nth pieces of variation information which is information related to the viewpoint variation for each of the first to Nth processing target images in the rendering; and
acquire first to Nth estimated images based on the first to Nth input images, the first to Nth pieces of the variation information, and a machine learning model, the estimated images each having an estimated pixel count greater than the input pixel count.

13. A computer-implemented method for image processing method comprising:
acquiring an input image based on a processing target image, the processing target image having a predetermined initial pixel count and showing, from a predetermined viewpoint, a virtual space in which one or more objects represented by three-dimensional data are arranged, and the input image having an input pixel count equal to or greater than the initial pixel count;
acquiring virtual space information, which is information about the virtual space available for determining a pixel value of each pixel in the processing target image; and
acquiring an estimated image having an estimated pixel count greater than the input pixel count based on the input image, the virtual space information, and a machine learning model,
wherein the machine learning model is trained using multiple training data sets, each of which includes a training input image, training virtual space information, and a training estimated image,
the training input image is an image having the input pixel count based on a training processing target image having the initial pixel count and showing, from the predetermined viewpoint, a training virtual space in which one or more training objects represented by training three-dimensional data are arranged,
the training virtual space information is information about the training virtual space available for determining a pixel value of each pixel in the training processing target image, and the training estimated image is an image having the estimated pixel count.

14. The image processing system according to claim 12, wherein the machine learning model includes an accumulated feature information output layer and an estimated image output layer,
wherein the accumulated feature information output layer receives the nth input image (n=2, 3, . . . , N), the nth piece of the variation information, and an n−1th piece of accumulated feature information indicating features of first to n−1th input images, and outputs an nth piece of the accumulated feature information indicating features of the first to nth input images, and
the estimated image output layer receives the nth piece of the accumulated feature information and outputs the nth estimated image.

15. The image processing system according to claim 14, wherein the machine learning model has been trained using multiple training data sets, each of which includes first to Nth training input images, first to Nth pieces of training variation information, and first to Nth training estimated images,
the nth training input image is an image having the input pixel count based on the nth training processing target image having the initial pixel count and showing, from the predetermined viewpoint, a training virtual space in which one or more training objects represented by training three-dimensional data are arranged,
each of the training processing target images is an image acquired by rendering the training three-dimensional data so that the viewpoint varies for each training processing target image according to a predetermined sequence,
the nth piece of the training variation information is information related to the viewpoint variation of the nth training processing target image in the rendering of the training three-dimensional data, and
the nth training estimated image is an image having the estimated pixel count.

16. The computer-implemented method according to claim 13, wherein the virtual space information has a same pixel count as the input pixel count.

17. The computer-implemented method according to claim 13, wherein the virtual space information includes depth information indicating a depth of an object of the one or more objects in the virtual space, the object being displayed at each pixel in the input image.

18. The computer-implemented method according to claim 13, wherein the virtual space information includes texture information indicating a texture of an object of the one or more objects displayed at each pixel in the input image.

19. The computer-implemented method according to claim 13, comprising:
acquiring first to Nth input images based on first to Nth processing target images arranged in chronological order, wherein Nis a natural number greater than or equal to 2;
acquiring first to Nth pieces of the virtual space information corresponding to the first to Nth input images, respectively; and
acquiring first to Nth estimated images based on the first to Nth input images, the first to Nth pieces of the virtual space information, and the machine learning model.

20. The computer-implemented method according to claim 19, wherein
the machine learning model includes an accumulated feature information output layer and an estimated image output layer,
the accumulated feature information output layer receives the nth input image, wherein n is an integer greater than or equal to 1, the nth piece of the virtual space information, and an n−1th piece of accumulated feature information indicating features of first to n−1th input images, and outputs an nth piece of the accumulated feature information indicating features of the first to nth input images, and
the estimated image output layer receives the nth piece of the accumulated feature information and outputs the nth estimated image.
